(19) United States
(12) Patent Application Publication
(10) Pub. No.: US 2026/0142524 A1
(43) Pub. Date: May 21, 2026

(54) ROTOR ATTACHMENTS FOR ELECTRIC MOTORS

(71) Applicant: Donut Lab Development Oü, Harju maakond (EE)

(72) Inventors: Ville Piippo, Haarajoki (FI); Marko Lehtimäki, Hyllykallio (FI); Tuomo Lehtimäki, Monaco (MC); Tero Ohranen, Tallinn (EE); Antti Alasalmi, Seinäjoki (FI); Harri Yli-Kujala, Helsinki (FI)

(21) Appl. No.: 19/274,786

(22) Filed: Jul. 21, 2025

Related U.S. Application Data
(60) Provisional application No. 63/722,229, filed on Nov. 19, 2024.

(51) Int. Cl. H02K 7/116; B60B 27/00; B60K 7/00; F16H 1/46; F16H 37/02; F16H 55/17; F16H 55/30; F16H 57/02; F16H 57/031

(52) U.S. Cl. CPC H02K 7/116; B60B 27/0047; B60K 7/0007; F16H 1/46; F16H 37/02; F16H 55/17; F16H 55/171; F16H 55/30; F16H 57/031; B60B 2360/30; B60B 2360/50; B60K 2007/0092; F16H 2057/02034; F16H 2057/02073

(57) ABSTRACT

Rotor attachments for electric motors are described. An example electric motor comprises a stator, a rotor, and a sprocket. The rotor circumscribes the stator. The rotor is configured to rotate relative to the stator. The sprocket circumscribes the rotor. The sprocket is coupled to the rotor such that rotation of the rotor causes a corresponding rotation of the sprocket. The sprocket includes a plurality of teeth projecting in a radially-outward direction. Respective ones of the plurality of teeth are configured to operatively engage a structure such that the corresponding rotation of the sprocket causes movement of the structure.

### RELATED APPLICATIONS

This application claims priority to U.S. Provisional Ser. No. 63/722,229, filed Nov. 19, 2024. The entirety of U.S. Provisional Ser. No. 63/722,229 is hereby incorporated by reference herein.

### FIELD OF THE DISCLOSURE

This disclosure relates generally to electric motors and, more specifically, to rotor attachments for electric motors.

### BACKGROUND

Electric motors typically include a stator and a rotor, with the rotor being configured to rotate relative to the stator. The stator and the rotor can be implemented in either an inner rotor configuration in which the stator circumscribes the rotor, or conversely in an outer rotor configuration in which the rotor circumscribes the stator. The output of a rotor of an electric motor is typically transferred (e.g., via one or more operative coupling(s)) to another structure and/or device such that rotation of the rotor results in some form of movement (e.g., rotation, translation, etc.) of the structure and/or device. Electric motors are widely used across multiple industries (e.g., automotive, medical, household, etc.) and a variety of applications including vehicles, appliances, tools, fans, blowers, turbines, compressors, pumps, etc.

### BRIEF DESCRIPTION OF THE DRAWINGS

FIG. 1 is a perspective view of an example electric motor including an example rotor and an example sprocket coupled to the rotor.

FIG. 2 is an exploded view of the electric motor of FIG. 1

FIG. 3 is a perspective view of an example electric motor including an example rotor and an example sprocket integrally formed with the rotor.

FIG. 4 is a perspective view of an example electric motor including an example rotor and an example planetary gear assembly operatively coupled to the rotor, with certain components of the planetary gear assembly shown.

FIG. 5 is a perspective view of the electric motor of FIG. 4, with additional components of the planetary gear assembly shown.

FIG. 6 is a perspective view of the electric motor of FIGS. 4 and 5, with additional components of the planetary gear assembly shown.

FIG. 7 is another perspective view of the electric motor of FIGS. 4-6.

FIG. 8 is a perspective view of an example electric motor including a modified version of the planetary gear assembly of FIGS. 4-7.

FIG. 9 is another perspective view of the electric motor of FIG. 8.

FIG. 10 is a perspective view of an example wheel including an example electric motor and an example airless tire.

FIG. 11 is a perspective view of an example wheel including an example electric motor, a plurality of example foldable spokes, and an example airless tire, with the foldable spokes and the airless tire shown in a deployed position relative to the electric motor.

FIG. 12 is another perspective view of the wheel of FIG. 11, with the foldable spokes and the airless tire shown in the deployed position relative to the electric motor.

FIG. 13 is a perspective view of the wheel of FIGS. 11 and 12, with the foldable spokes shown in a stowed position relative to the electric motor.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Electric motors are widely used across multiple industries (e.g., automotive, medical, household, etc.) and a variety of applications including vehicles, appliances, tools, fans, blowers, turbines, compressors, pumps, etc. The output of a rotor of an electric motor is typically transferred (e.g., via one or more operative coupling(s)) to another structure and/or device such that rotation of the rotor results in some form of movement (e.g., rotation, translation, etc.) of the structure and/or device. Electric motors disclosed herein include one or more structure(s) coupled and/or attached (e.g., directly coupled and/or attached) to the rotor of the electric motor.

In some disclosed examples, an electric motor includes a rotor having a sprocket coupled and/or attached to the rotor. In some such examples, the sprocket is coupled and/or attached to the rotor via one or more fastener(s). In other such examples, the sprocket is integrally formed with the rotor. The sprocket of the electric motor includes a plurality of teeth that respectively project and/or extend in a radially-outward direction. The teeth of the sprocket can be shaped, spaced, and/or otherwise configured to facilitate an operative engagement between the sprocket of the electric motor and one or more other structure(s) (e.g., a surface, a gear, a belt, a chain, a cable, a cord, etc.). As a result of the sprocket of the electric motor being coupled and/or attached to the rotor of the electric motor, rotation of the rotor causes a corresponding rotation of the sprocket, which in turn causes movement (e.g., rotation, translation, etc.) of a structure that engages with the teeth of the sprocket.

Electric motors configured as described above (and further described herein) can be used with and/or incorporated into many different types of applications. As one example, the electric motor can be used with and/or incorporated into various manufacturing lines requiring movement of an object (e.g., a surface, a gear, a belt, a chain, a cable, a cord, etc.). As another example, the electric motor can be used with and/or incorporated into various vehicles having a track-based propulsion system (e.g., snowmobiles, excavators, etc.). Implementations in which the sprocket of the electric motor is removably coupled to the rotor of the electric motor are particularly useful for applications having long lifetimes that typically require maintenance of the electric motor and/or replacement of the parts thereof. For example, with the sprocket being detachable and/or removable from the rotor of the electric motor, the sprocket can be easily replaced once it becomes worn or damaged. Conversely, implementations in which the sprocket of the electric motor is integrally formed with the rotor of the electric motor are particularly useful for applications in which maintenance of the electric motor and/or replacement of the parts thereof is/are not typically required.

In some disclosed examples, an electric motor includes a rotor having a planetary gear assembly coupled and/or attached to the rotor, with the planetary gear assembly including a sprocket. The planetary gear assembly of the electric motor is advantageously configured to enable the sprocket of the electric motor to have a different rotational speed (e.g., stepped up from, or stepped down from) relative to the rotational speed of the rotor of the electric motor. In some examples, the electric motor is accordingly able to advantageously generate a greater amount of torque at the sprocket of the electric motor using a lower rotational speed of the rotor of the electric motor. The planetary gear assembly of the electric motor can be modified to include different numbers, different types, and different sizes of gears suitable to achieve any desired relationship between the rotational speed of the rotor of the electric motor and the rotational speed of the sprocket of the electric motor.

Electric motors including a planetary gear assembly configured as described above (and further described herein) can be used with and/or incorporated into many different types of applications. For example, the electric motor can be used with and/or incorporated into robotics in manufacturing, humanoid and other autonomous robots, conveyor belts, and various automotive use cases such as drive-by-wire steering and active suspension. As another example, the electric motor can be used with and/or incorporated into large machines used in agriculture, forestry, mining, and/or construction (e.g., excavators, harvesters, etc.). Incorporation of the planetary gear assembly into the electric motor advantageously results in an ultra-compact motor design that generates substantial torque in low rotational speed (e.g., low RPM) use cases. A system incorporating the electric motor therefore requires much less current and/or power to generate a certain amount of torque. Alternatively, a system incorporating the electric motor can be designed with smaller outer dimensions while still being able to generate the same current and/or power as a relatively larger sized electric motor that lacks the planetary gear assembly.

In some disclosed examples, an electric motor can be incorporated into a wheel that includes an airless tire, with the airless tire being coupled and/or attached to the rotor of the electric motor. In some examples, one or more portion(s) of the airless tire is/are formed from plastic or rubber. Wheels including an electric motor and an airless tire configured as described above (and further described here) can be used with and/or incorporated into many different types of applications. For example, the wheel can be used with and/or incorporated into various wheel-based vehicles (e.g., cars, trucks, motorcycles, scooters, etc.). By eliminating any need for a separate inner liner, belt, and/or beads configured to retain compressed air, the airless tire of the wheel offers numerous advantages over traditional air-filled tires with regard to weight savings, cost reduction, rotor diameter maximization, and performance optimization.

In some disclosed examples, an electric motor can be incorporated into a wheel that includes an airless tire that is selectively coupled and/or attached to the rotor of the electric motor via a plurality of foldable spokes. An outer tread of the airless tire circumscribes and is spaced radially apart from the rotor of the electric motor when the foldable spokes and the airless tire are deployed from an open central region of the electric motor. In some examples, the outer tread of the airless tire is formed from plastic or rubber. When the airless tire of the wheel is not in use (e.g., when the wheel and/or a vehicle to which the wheel is attached is/are actively being transported), the foldable spokes can be rotated inwardly within the open central region of the electric motor, and stowed therein. The outer tread of the airless tire can also be located and/or stowed within the open central region when the wheel is not in use.

Wheels including an electric motor, an airless tire, and foldable spokes configured as described above (and further described here) can be used with and/or incorporated into many different types of applications. For example, the wheel can be used with and/or incorporated into various wheel-based vehicles (e.g., cars, trucks, motorcycles, scooters, etc.). In some examples, the wheel is particularly suitable for use with and/or incorporation into a moon buggy that is configured for space exploration. Some modern moon buggies include shape memory metal tires that compress (e.g., retract) when the moon buggy is in transport and decompress (e.g. expand) when the moon buggy is in drive mode. The airless tire of the wheel offers numerous advantages over shape memory metal tires with regard to weight savings, cost reduction, and performance optimization.

In some disclosed examples, an electric motor can be incorporated into an apparatus or a system in which a wire or cable is to be let out or pulled in. In such examples, the wire or cable can be coupled and/or attached to the rotor of an electric motor. In some examples, the exterior surface of the rotor of the electric motor can be configured with one or more groove(s) and/or track(s) that facilitate guided winding of the wire or cable around the rotor of the electric motor as the rotor of the electric motor rotates. Use cases for such an electric motor include, for example, a winch system.

As used herein, the term “electric machine(s)” encompasses electric motor(s) configured to transform electrical energy into mechanical energy, and further encompasses electric generator(s) configured to transform mechanical energy into electrical energy.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

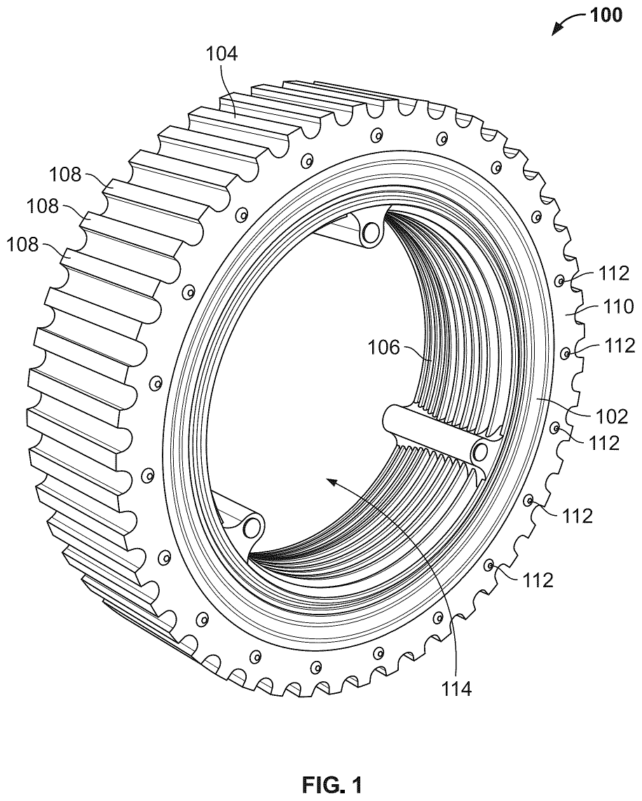

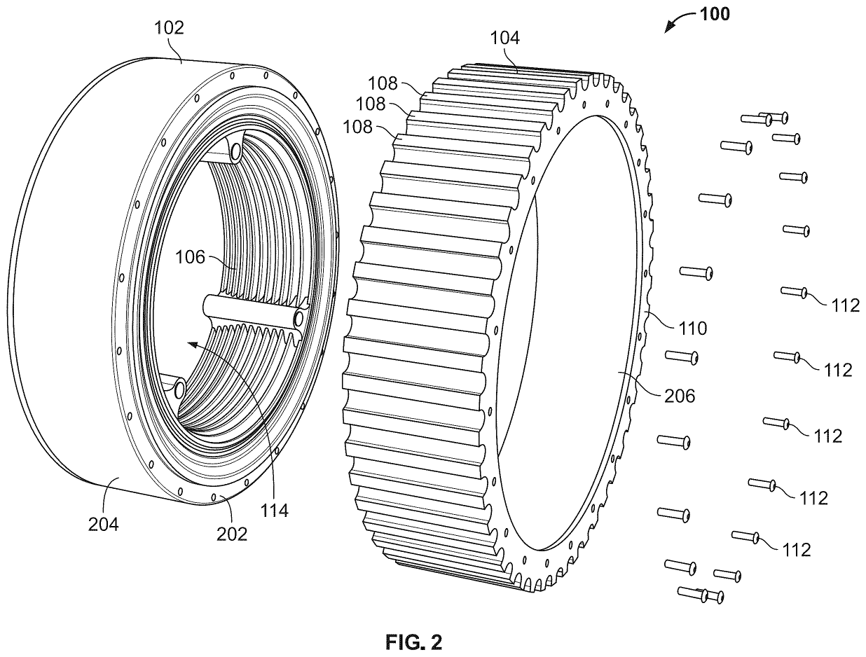

FIG. 1 is a perspective view of an example electric motor 100 including an example rotor 102 and an example sprocket 104 coupled to the rotor 102. FIG. 2 is an exploded view of the electric motor 100 of FIG. 1. The rotor 102 of the electric motor 100 of FIGS. 1 and 2 is configured to rotate relative to an example stator 106 of the electric motor 100. In the illustrated example of FIGS. 1 and 2, the electric motor 100 has an outer-rotor configuration in which the rotor 102 circumscribes the stator 106. In other example, the electric motor 100 can instead have an inner-rotor configuration in which the stator 106 circumscribes the rotor 102.

The sprocket 104 of FIGS. 1 and 2 circumscribes the rotor 102 of the electric motor 100. In this regard, the sprocket 104 of FIGS. 1 and 2 has an annular shape that is configured to slide over the rotor 102 of the electric motor 100 to facilitate attachment of the sprocket 104 to the rotor 102. As shown in FIGS. 1 and 2, the sprocket 104 includes a plurality of example teeth 108 that respectively project and/or extend in a radially-outward direction. The teeth 108 of the sprocket 104 can be shaped, spaced, and/or otherwise configured to facilitate an operative engagement between the sprocket 104 and one or more other structure(s) (e.g., a surface, a gear, a belt, a chain, a cable, a cord, etc.). In the illustrated example of FIGS. 1 and 2, the sprocket 104 has an axial width that is substantially equal to a corresponding axial width of the rotor 102. In other examples, the axial width of the sprocket 104 can instead be substantially less than the axial width of the rotor 102. In still other examples, the axial width of the sprocket 104 can instead be substantially greater than the axial width of the rotor 102.

When the electric motor 100 of FIGS. 1 and 2 is assembled (e.g., as shown in FIG. 1), the sprocket 104 is coupled to the rotor 102 of the electric motor 100 such that rotation of the rotor 102 causes a corresponding rotation of the sprocket 104. In the illustrated example of FIGS. 1 and 2, the rotor 102 includes an example face 202 (e.g., a side) having a plurality of openings formed therein. The sprocket 104 includes an example lip 110 having a corresponding plurality of openings formed therein and extending therethrough. The openings of the lip 110 of the sprocket 104 are configured to align with the openings of the face 202 of the rotor 102 when the sprocket 104 is positioned for attachment to the rotor 102. Attachment of the sprocket 104 to the rotor 102 is facilitated via a plurality of example fasteners 112 that extend through respective ones of the openings formed in the lip 110 of the sprocket and into corresponding respective ones of the openings formed in the face 202 of the rotor 102, thereby coupling the sprocket 104 to the rotor 102. The electric motor 100 of FIGS. 1 and 2 further includes an example open central region 114 (e.g., a hollow center) that is located radially inward relative to the sprocket 104, relative to the rotor 102, and/or relative to the stator 106 of the electric motor 100. As shown in FIG. 1, the open central region 114 of the electric motor 100 is unobstructed by the sprocket 104 when the sprocket 104 is attached and/or coupled to the rotor 102.

In the illustrated example of FIGS. 1 and 2, an example exterior surface 204 of the rotor 102 and an example interior surface 206 of the sprocket 104 of the electric motor 100 are respectively smooth and/or uninterrupted (e.g., free of projections, recesses, etc.). In other examples, the exterior surface 204 of the rotor 102 can include one or more outwardly-extending projection(s) and the interior surface 206 of the sprocket 104 can include one or more inwardly-extending projection(s), with the inwardly-extending projection(s) of the interior surface 206 of the sprocket 104 being configured to be interleaved with the outwardly-extending projection(s) of the exterior surface 204 of the rotor 102. In still other examples, the exterior surface 204 of the rotor 102 can include one or more outwardly-extending projection(s) and the interior surface 206 of the sprocket 104 can include a corresponding one or more outwardly-extending recess(es) that complement and/or are configured to be engaged by the outwardly-extending projection(s). In still other examples, the interior surface 206 of the sprocket 104 can include one or more inwardly-extending projection(s) and the exterior surface 204 of the rotor 102 can include a corresponding one or more inwardly-extending recess(es) that complement and/or are configured to be engaged by the inwardly-extending projection(s). Engagement of the above-described projection(s) and/or recess(es) advantageously assists with transferring torque from the rotor 102 of the electric motor 100 to the sprocket 104 of the electric motor 100.

The electric motor 100 of FIGS. 1 and 2 can be used with and/or incorporated into many different types of applications. As one example, the electric motor 100 of FIGS. 1 and 2 can be used with and/or incorporated into various manufacturing lines requiring movement of an object (e.g., a surface, a gear, a belt, a chain, a cable, a cord, etc.). As another example, the electric motor 100 of FIGS. 1 and 2 can be used with and/or incorporated into various vehicles having a track-based propulsion system (e.g., snowmobiles, excavators, etc.). Furthermore, the configuration of the electric motor 100 of FIGS. 1 and 2 is particularly useful for applications having long lifetimes that typically require maintenance of the electric motor 100 and/or replacement of the parts thereof. For example, with the sprocket 104 being detachable and/or removable from the rotor 102 of the electric motor 100, the sprocket 104 can be easily replaced once it becomes worn or damaged.

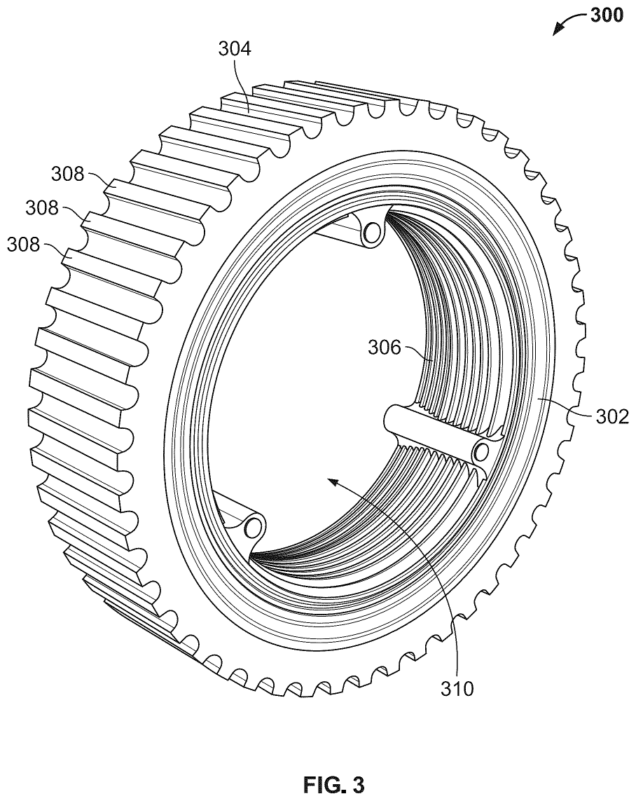

FIG. 3 is a perspective view of an example electric motor 300 including an example rotor 302 and an example sprocket 304 integrally formed with the rotor 302. Much like the electric motor 100 of FIGS. 1 and 2 described above, the rotor 302 of the electric motor 300 of FIG. 3 is configured to rotate relative to an example stator 306 of the electric motor 300, with the electric motor 300 having an outer-rotor configuration in which the rotor 302 circumscribes the stator 306. The sprocket 304 of FIG. 3 circumscribes the rotor 302 of the electric motor 300. As shown in FIG. 3, the sprocket 304 includes a plurality of example teeth 308 that respectively project and/or extend in a radially-outward direction. The teeth 308 of the sprocket 304 can be shaped, spaced, and/or otherwise configured to facilitate an operative engagement between the sprocket 304 and one or more other structure(s) (e.g., a surface, a gear, a belt, a chain, a cable, a cord, etc.). With the sprocket 304 of the electric motor 300 being integrally formed with the rotor 302 of the electric motor 300, rotation of the rotor 302 (e.g., relative to the stator 306) causes a corresponding rotation of the sprocket 304. The electric motor 300 of FIG. 3 further includes an example open central region 310 (e.g., a hollow center) that is located radially inward relative to the sprocket 304, relative to the rotor 302, and/or relative to the stator 306 of the electric motor 300. As shown in FIG. 3, the open central region 310 of the electric motor 300 is unobstructed by the sprocket 304 of the electric motor 300.

Integrally forming the sprocket 304 with the rotor 302 advantageously reduces the number of components of the electric motor 300 of FIG. 3 relative the number of components of the electric motor 100 of FIGS. 1 and 2 described above. For example, integrally forming the sprocket 304 with the rotor 302 of the electric motor 300 as shown in FIG. 3 advantageously eliminates any need for the fasteners 112 of the electric motor 100 of FIGS. 1 and 2 described above, and also eliminates any need for the associated openings that would otherwise be formed in the lip 110 of the sprocket 104 and/or the face 202 of the rotor 102. The assembly of the electric motor 300 of FIG. 3 is accordingly simplified (e.g., requires fewer assembly steps and/or components) relative to the assembly of the electric motor 100 of FIGS. 1 and 2.

The electric motor 300 of FIG. 3 can be used with and/or incorporated into many different types of applications. As one example, the electric motor 300 of FIG. 3 can be used with and/or incorporated into various manufacturing lines requiring movement of an object (e.g., a surface, a gear, a belt, a chain, a cable, a cord, etc.). As another example, the electric motor 300 of FIG. 3 can be used with and/or incorporated into various vehicles having a track-based propulsion system (e.g., snowmobiles, excavators, etc.). Furthermore, the configuration of the electric motor 300 of FIG. 3 is particularly useful for applications in which maintenance of the electric motor 300 and/or replacement of the parts thereof is/are not typically required.

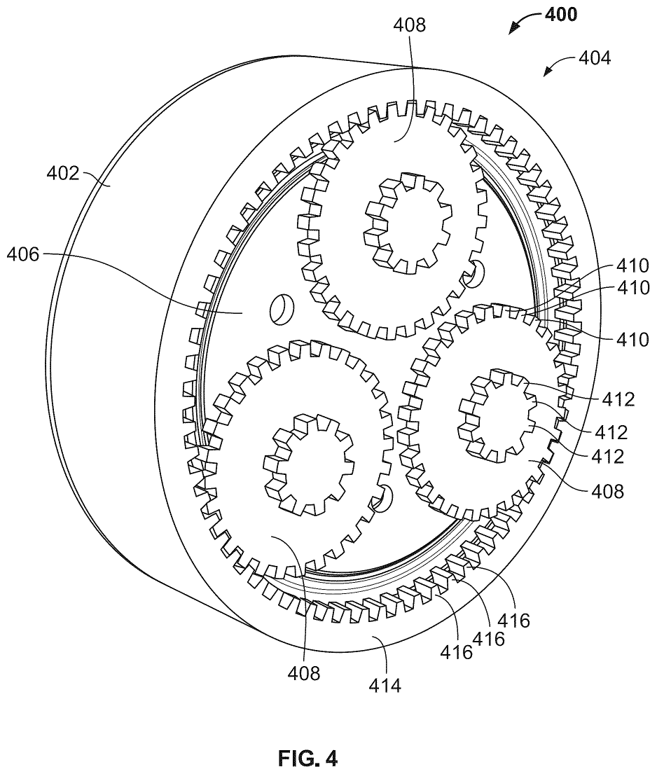

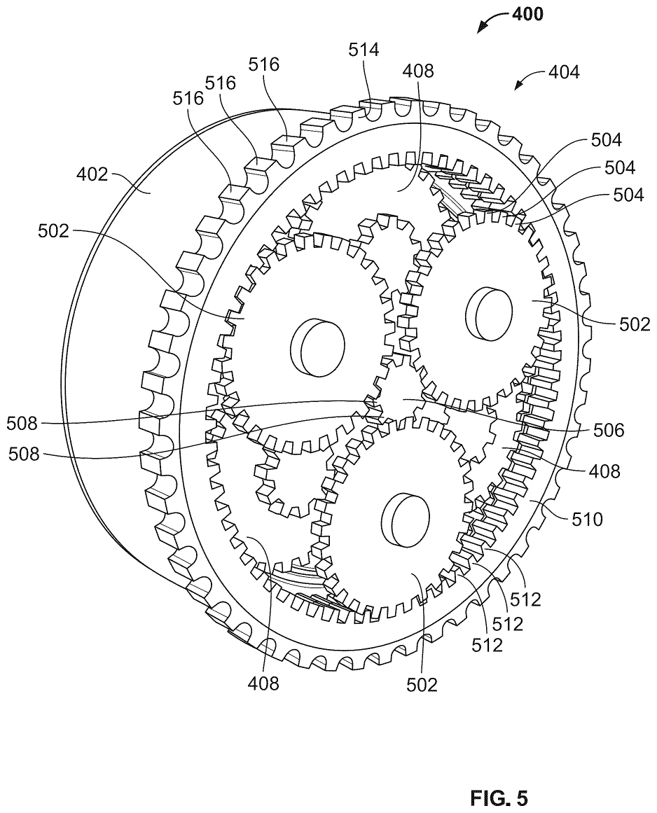

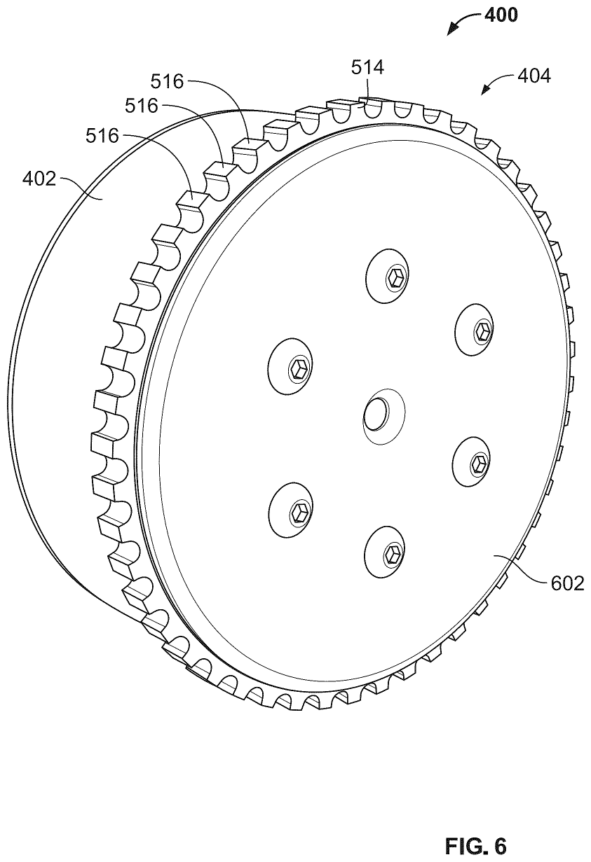

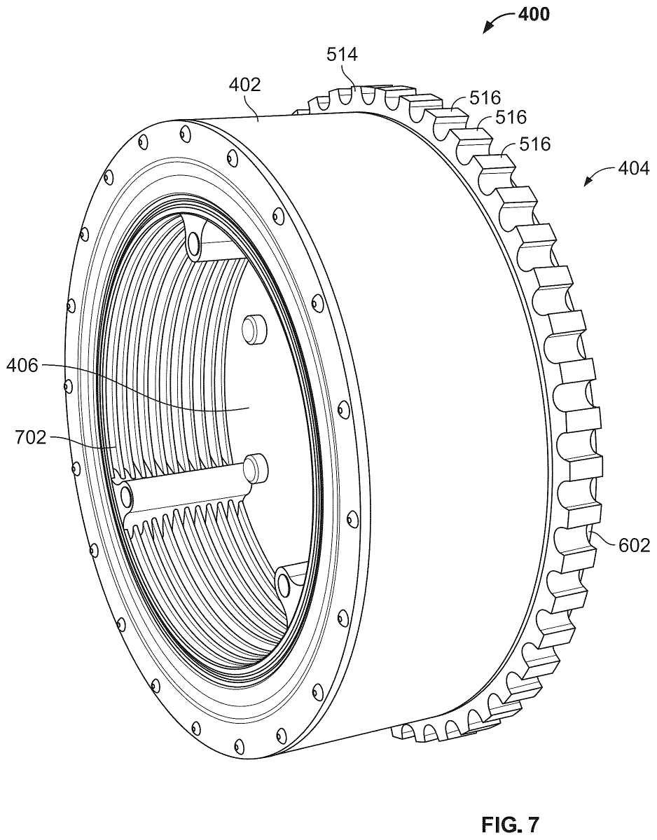

FIG. 4 is a perspective view of an example electric motor 400 including an example rotor 402 and an example planetary gear assembly 404 operatively coupled to the rotor 402, with certain components of the planetary gear assembly 404 shown. FIG. 5 is a perspective view of the electric motor 400 of FIG. 4, with additional components of the planetary gear assembly 404 shown. FIG. 6 is a perspective view of the electric motor 400 of FIGS. 4 and 5, with additional components of the planetary gear assembly 404 shown. FIG. 7 is another perspective view of the electric motor of FIGS. 4-6. The rotor 402 of the electric motor 400 of FIGS. 4-7 is configured to rotate relative to an example stator 702 of the electric motor 400. The electric motor 400 of FIGS. 4-7 has an outer-rotor configuration in which the rotor 402 circumscribes the stator 702.

The planetary gear assembly 404 of FIGS. 4-7 includes an example attachment plate 406. In some examples, the attachment plate 406 of the planetary gear assembly 404 is coupled (e.g., via one or more fastener(s)) to the stator 702 of the electric motor 400 such that the attachment plate 406 is fixed relative to the stator 702. In other examples, the attachment plate 406 can instead be integrally formed with the stator 702. The attachment plate 406 functions as a base for various gears of the planetary gear assembly 404, as further described herein.

The planetary gear assembly 404 of FIGS. 4-7 further includes an example set of first planet gears 408. Each one of the first planet gears 408 is rotatably coupled to the attachment plate 406 such that each one of the first planet gears 408 can rotate about its corresponding central axis relative to the attachment plate 406. In the illustrated example of FIGS. 4-7, each one of the first planet gears 408 is configured as a step gear having a plurality of example first teeth 410 that respectively project and/or extend in a radially-outward direction relative to the central axis of the step gear, and a plurality of example second teeth 412 that respectively project and/or extend in a radially-outward direction relative to the central axis of the step gear, with the first teeth 410 being stepped axially inward relative to the second teeth 412. In the illustrated example of FIGS. 4-7, a first circumference of the step gear defined by the first teeth 410 is greater than a second circumference of the step gear defined by the second teeth 412. In other examples, the first circumference of the step gear defined by the first teeth 410 can instead be less than the second circumference of the step gear defined by the second teeth 412. In still other examples, the first circumference of the step gear defined by the first teeth 410 can instead be substantially equal to the second circumference of the step gear defined by the second teeth 412.

The planetary gear assembly 404 of FIGS. 4-7 further includes an example first ring gear 414. In the illustrated example of FIGS. 4-7, the first ring gear 414 is integrally formed with the rotor 402 of the electric motor 400. Rotation of the rotor 402 of the electric motor 400 accordingly causes a corresponding rotation of the first ring gear 414. In other examples, the first ring gear 414 can instead be coupled (e.g., via one or more fastener(s)) to the rotor 402 such that rotation of the rotor 402 causes a corresponding rotation of the first ring gear 414. In the illustrated example of FIGS. 4-7, the first ring gear 414 includes a plurality of example teeth 416 that respectively project and/or extend in a radially-inward direction relative to a central axis of the first ring gear 414. The teeth 416 of the first ring gear 414 are configured to operatively engage the first teeth 410 of respective ones of the first planet gears 408. Rotation of the first ring gear 414 (e.g., via rotation of the rotor 402 of the electric motor 400) accordingly causes rotation of the respective ones of the first planet gears 408, including the first teeth 410 and the second teeth 412 thereof.

The planetary gear assembly 404 of FIGS. 4-7 further includes an example set of second planet gears 502. Each one of the second planet gears 502 is rotatably coupled to the attachment plate 406 such that each one of the second planet gears 502 can rotate about its corresponding central axis relative to the attachment plate 406. In the illustrated example of FIGS. 4-7, each one of the second planet gears 502 includes a plurality of example teeth 504 that respectively project and/or extend in a radially-outward direction relative to the central axis of the second planet gear 502. The teeth 504 of each one of the second planet gears 502 are configured to operatively engage the second teeth 412 of two of the respective ones of the first planet gears 408. Rotation of the first planet gears 408 (e.g., via rotation of the first ring gear 414) accordingly causes rotation of the respective ones of the second planet gears 502, including the teeth 504 thereof.

The planetary gear assembly 404 of FIGS. 4-7 further includes an example central gear 506. In the illustrated example of FIGS. 4-7, the central gear 506 includes a plurality of example teeth 508 that respectively project and/or extend in a radially-outward direction relative to the central axis of the central gear 506. The teeth 508 of the central gear 506 are configured to operatively engage the first teeth 410 of the respective ones of the first planet gears 408 and/or the teeth 504 of the respective ones of the second planet gears 502. Rotation of the first planet gears 408 (e.g., via rotation of the first ring gear 414) accordingly causes rotation of the central gear 506 (including the teeth 508 thereof) and rotation of the respective ones of the second planet gears 502 (including the teeth 504 thereof).

The planetary gear assembly 404 of FIGS. 4-7 further includes an example second ring gear 510. In the illustrated example of FIGS. 4-7, the second ring gear 510 includes a plurality of example teeth 512 that respectively project and/or extend in a radially-inward direction relative to a central axis of the second ring gear 510. The teeth 512 of the second ring gear 510 are configured to operatively engage the teeth 504 of respective ones of the second planet gears 502. Rotation of the respective ones of the second planet gears 502 (e.g., via rotation of the central gear 506 and/or rotation of the first planet gears 408) accordingly causes rotation of the second ring gear 510.

The planetary gear assembly 404 of FIGS. 4-7 further includes an example sprocket 514. In the illustrated example of FIGS. 4-7, the sprocket 514 is integrally formed with the second ring gear 510. Rotation of the second ring gear 510 of the planetary gear assembly 404 accordingly causes a corresponding rotation of the sprocket 514. In the illustrated example of FIGS. 4-7, the sprocket 514 includes a plurality of example teeth 516 that respectively project and/or extend in a radially-outward direction. The teeth 516 of the sprocket 514 can be shaped, spaced, and/or otherwise configured to facilitate an operative engagement between the sprocket 514 and one or more other structure(s) (e.g., a surface, a gear, a belt, a chain, a cable, a cord, etc.). In the illustrated example of FIGS. 4-7, the sprocket 514 has an axial width that is substantially equal to a corresponding axial width of the second ring gear 510. In other examples, the axial width of the sprocket 514 can instead be greater than the axial width of the second ring gear 510. For example, the axial width of the sprocket 514 can be substantially equal to the axial width of the rotor 402 of the electric motor 400.

The planetary gear assembly 404 of FIGS. 4-7 further includes an example cover plate 602. The cover plate 602 is configured to be coupled (e.g., via one or more fastener(s)) to a portion of the electric motor 400. The cover plate 602 retains and/or secures the first planet gears 408, the second planet gears 502, the central gear 506, the second ring gear 510, and/or the sprocket 514 relative to the stator 702 and/or relative to the rotor 402 of the electric motor 400.

In the illustrated example of FIGS. 4-7, the planetary gear assembly 404 is advantageously configured to facilitate rotation of the sprocket 514 of the electric motor 400 at a rotational speed that is less than (e.g., stepped down from) a rotational speed of the rotor 402 of the electric motor 400. The electric motor 400 is accordingly able to advantageously generate a greater amount of torque at the sprocket 514 of the electric motor 400 using a lower rotational speed of the rotor 402 of the electric motor 400. In other examples, the planetary gear assembly 404 can instead be configured to facilitate rotation of the sprocket 514 of the electric motor 400 at a rotational speed that is greater than (e.g., stepped up from) a rotational speed of the rotor 402 of the electric motor 400.

In some examples, one or more component(s) (e.g., one or more gear(s)) of the planetary gear assembly 404 can be either engaged to or disengaged from one or more other component(s) (e.g., one or more other gear(s)) of the planetary gear assembly 404 by moving (e.g., in an axial direction) at least one component of the planetary gear assembly 404, or by moving (e.g., in an axial direction) the entire planetary gear assembly 404. Such an arrangement advantageously enables operation of the electric motor 400 with two different gears: (1) direct drive with normal rotor speed via the rotor 402; and (2) reduced/increased speed via the planetary gear assembly 404. The planetary gear assembly 404 can be modified to include different numbers, different types, and different sizes of gears suitable to achieve any desired relationship between the rotational speed of the rotor 402 of the electric motor 400 and the rotational speed of the sprocket 514 of the electric motor 400.

The electric motor 400 of FIGS. 4-7 can be used with and/or incorporated into many different types of applications. For example, the electric motor 400 of FIGS. 4-7 can be used with and/or incorporated into robotics in manufacturing, humanoid and other autonomous robots, conveyor belts, and various automotive use cases such as drive-by-wire steering and active suspension. As another example, the electric motor 400 of FIGS. 4-7 can be used with and/or incorporated into large machines used in agriculture, forestry, mining, and/or construction (e.g., excavators, harvesters, etc.). Incorporation of the planetary gear assembly 404 into the electric motor 400 advantageously results in an ultra-compact motor design that generates substantial torque in low rotational speed (e.g., low RPM) use cases. A system incorporating the electric motor 400 of FIGS. 4-7 therefore requires much less current and/or power to generate a certain amount of torque. Alternatively, a system incorporating the electric motor 400 can be designed with smaller outer dimensions while still being able to generate the same current and/or power as a relatively larger sized electric motor that lacks the planetary gear assembly 404.

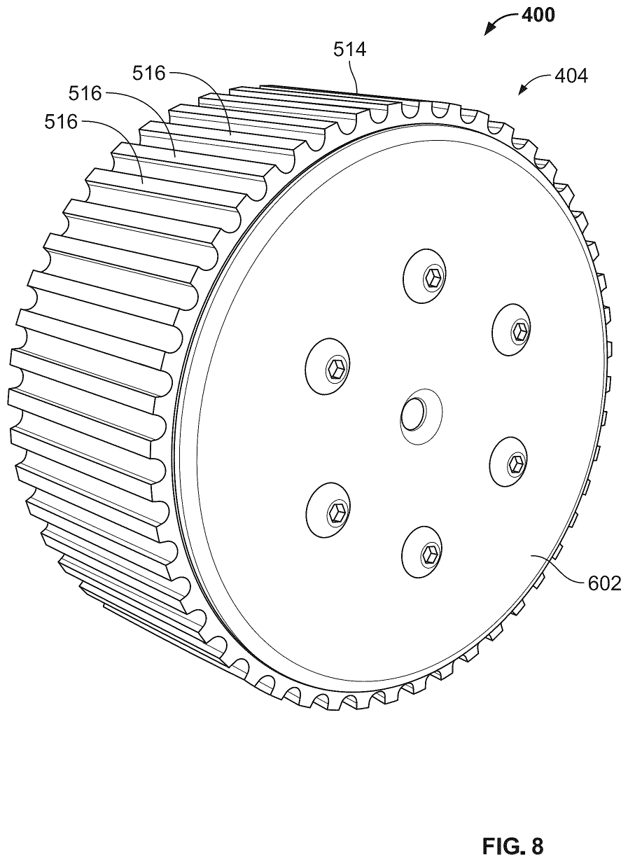

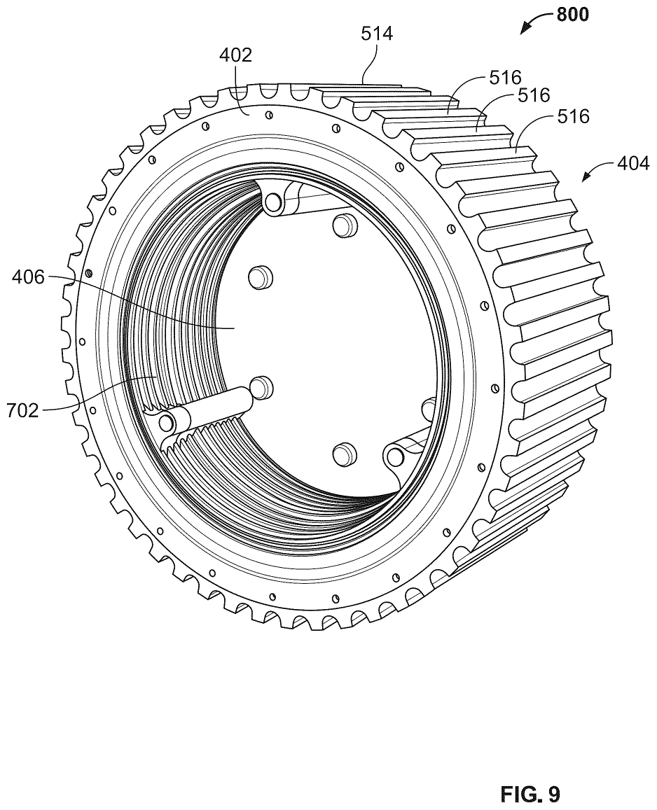

FIG. 8 is a perspective view of an example electric motor 800 including a modified version of the planetary gear assembly 404 of FIGS. 4-7. FIG. 9 is another perspective view of the electric motor 800 of FIG. 8. The electric motor 800 of FIGS. 8 and 9 is substantially identical to the electric motor 400 of FIGS. 4-7 described above, with the primary difference being in the structure of the sprocket 514 of the planetary gear assembly 404. In this regard, while the sprocket 514 of the electric motor 400 shown in FIGS. 4-7 has an axial width that is substantially equal to the axial width of the second ring gear 510 and substantially less than the axial width of the rotor 402 of the electric motor 400, the sprocket 514 of the electric motor 800 shown in FIGS. 8 and 9 instead has an axial width that is substantially greater than an axial width of the second ring gear 510 and substantially equal to the axial width of the rotor 402 of the electric motor 800.

The electric motor 800 of FIG. 8 can be used with and/or incorporated into many different types of applications. For example, the electric motor 800 of FIG. 8 can be used with and/or incorporated into robotics in manufacturing, humanoid and other autonomous robots, conveyor belts, and various automotive use cases such as drive-by-wire steering and active suspension. As another example, the electric motor 800 of FIG. 8 can be used with and/or incorporated into large machines used in agriculture, forestry, mining, and/or construction (e.g., excavators, harvesters, etc.). Incorporation of the planetary gear assembly 404 into the electric motor 800 advantageously results in an ultra-compact motor design that generates substantial torque in low rotational speed (e.g., low RPM) use cases. A system incorporating the electric motor 800 of FIG. 8 therefore requires much less current and/or power to generate a certain amount of torque. Alternatively, a system incorporating the electric motor 800 can be designed with smaller outer dimensions while still being able to generate the same current and/or power as a relatively larger sized electric motor that lacks the planetary gear assembly 404.

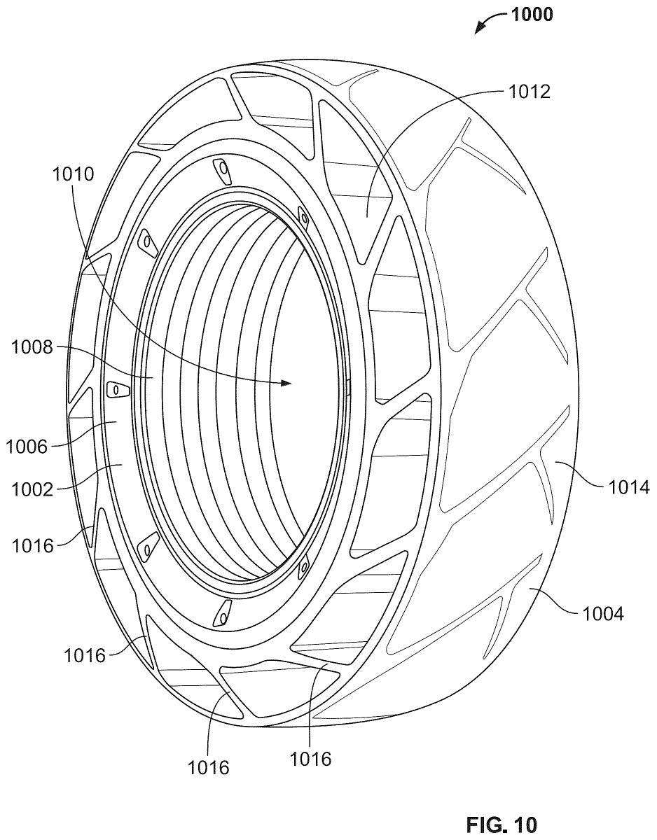

FIG. 10 is a perspective view of an example wheel 1000 including an example electric motor 1002 and an example airless tire 1004. The electric motor 1002 of FIG. 10 includes an example rotor 1006 and an example stator 1008. The rotor 1006 of the electric motor 1002 of FIG. 10 is configured to rotate relative to the stator 1008 of the electric motor 1002. As shown in FIG. 10, the electric motor 1002 has an outer-rotor configuration in which the rotor 1006 circumscribes the stator 1008. The electric motor 1002 of FIG. 10 further includes an example open central region 1010 (e.g., a hollow center) that is located radially inward relative to the rotor 1006, and/or relative to the stator 1008 of the electric motor 1002. As shown in FIG. 10, the open central region 1010 of the electric motor 1002 is unobstructed by the airless tire 1004 when the airless tire 1004 is attached and/or coupled to the rotor 1006.

In the illustrated example of FIG. 10, the airless tire 1004 includes an example inner core 1012, an example outer tread 1014 spaced radially apart from the inner core 1012, and a plurality of example flexible spokes 1016 extending between an exterior surface of the inner core 1012 and an interior surface of the outer tread 1014. In some examples, the inner core 1012, the flexible spokes 1016, and/or the outer tread 1014 of the airless tire 1004 is/are formed from plastic or rubber. The inner core 1012 of the airless tire 1004 is configured to be slid over the rotor 1006 of the electric motor 1002 when the wheel 1000 of FIG. 10 is being assembled. Assembly of the wheel 1000 results in the inner core 1012 of the airless tire 1004 being coupled directly to (e.g., mounted directly on) the rotor 1006 of the electric motor 1002 such that rotation of the rotor 1006 causes a corresponding rotation of the airless tire 1004, including the inner core 1012, the outer tread 1014, and the flexible spokes 1016 thereof.

In the illustrated example of FIG. 10, an exterior surface of the rotor 1006 of the electric motor 1002 and an example interior surface of the inner core 1012 of the airless tire 1004 are respectively smooth and/or uninterrupted (e.g., free of projections, recesses, etc.). In other examples, the exterior surface of the rotor 1006 can include one or more outwardly-extending projection(s) and the interior surface of the inner core 1012 can include one or more inwardly-extending projection(s), with the inwardly-extending projection(s) of the interior surface of the inner core 1012 being configured to be interleaved with the outwardly-extending projection(s) of the exterior surface of the rotor 1006. In still other examples, the exterior surface of the rotor 1006 can include one or more outwardly-extending projection(s) and the interior surface of the inner core 1012 can include a corresponding one or more outwardly-extending recess(es) that complement and/or are configured to be engaged by the outwardly-extending projection(s). In still other examples, the interior surface of the inner core 1012 can include one or more inwardly-extending projection(s) and the exterior surface of the rotor 1006 can include a corresponding one or more inwardly-extending recess(es) that complement and/or are configured to be engaged by the inwardly-extending projection(s). Engagement of the above-described projection(s) and/or recess(es) advantageously assists with transferring torque from the rotor 1006 of the electric motor 1002 to the inner core 1012 of the airless tire 1004.

The wheel 1000 of FIG. 10 can be used with and/or incorporated into many different types of applications. For example, the wheel 1000 of FIG. 10 can be used with and/or incorporated into various wheel-based vehicles (e.g., cars, trucks, motorcycles, scooters, etc.). By eliminating any need for a separate inner liner, belt, and/or beads configured to retain compressed air, the airless tire 1004 of the wheel 1000 of FIG. 10 offers numerous advantages over traditional air-filled tires with regard to weight savings, cost reduction, rotor diameter maximization, and performance optimization.

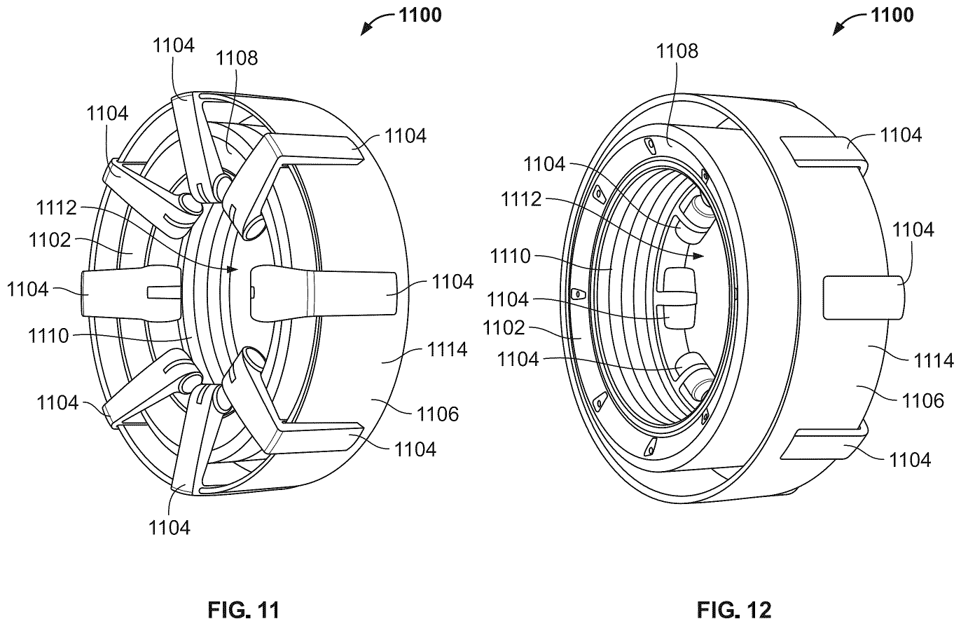

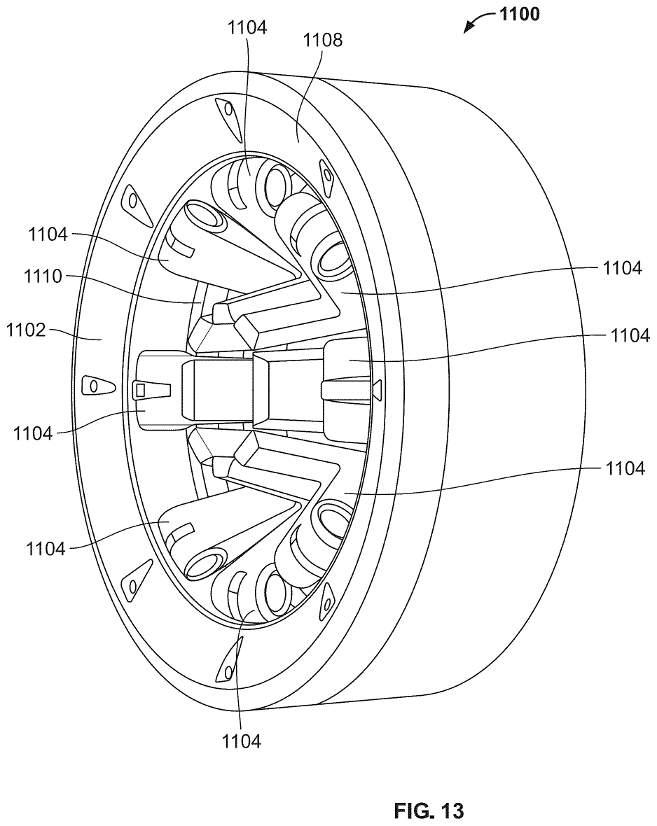

FIG. 11 is a perspective view of an example wheel 1100 including an example electric motor 1102, a plurality of example foldable spokes 1104, and an example airless tire 1106, with the foldable spokes 1104 and the airless tire 1106 shown in a deployed position relative to the electric motor 1102. FIG. 12 is another perspective view of the wheel 1100 of FIG. 11, with the foldable spokes 1104 and the airless tire 1106 shown in the deployed position relative to the electric motor 1102. FIG. 13 is a perspective view of the wheel 1100 of FIGS. 11 and 12, with the foldable spokes 1104 shown in a stowed position relative to the electric motor 1102. The electric motor 1102 of FIGS. 11-13 includes an example rotor 1108 and an example stator 1110. The rotor 1108 of the electric motor 1102 of FIGS. 11-13 is configured to rotate relative to the stator 1110 of the electric motor 1102. As shown in FIGS. 11-13, the electric motor 1102 has an outer-rotor configuration in which the rotor 1108 circumscribes the stator 1110. The electric motor 1102 of FIGS. 11-13 further includes an example open central region 1112 (e.g., a hollow center) that is located radially inward relative to the rotor 1108, and/or relative to the stator 1110 of the electric motor 1102. As shown in FIG. 13, the open central region 1112 of the electric motor 1102 is configured to receive at least the foldable spokes 1104 (and in some instances also the airless tire 1106) when the wheel 1100 of FIGS. 11-13 is not in use (e.g., when the wheel 1100 and/or a vehicle to which the wheel 1100 is attached is/are actively being transported).

In the illustrated example of FIGS. 11-13, the airless tire 1106 includes an example outer tread 1114 that is selectively coupled to the rotor 1108 of the electric motor 1102 via the foldable spokes 1104 of the wheel 1100 when the foldable spokes 1104 are in the deployed position shown in FIGS. 11 and 12. The outer tread 1114 of the airless tire 1106 circumscribes and is spaced radially apart from the rotor 1108 of the electric motor 1102 when the foldable spokes 1104 and the airless tire 1106 are deployed from the open central region 1112 of the electric motor 1102, as shown in FIGS. 11 and 12. In some examples, the outer tread 1114 of the airless tire 1106 is formed from plastic or rubber. Each one of the foldable spokes 1104 is rotatably coupled to the rotor 1108 of the electric motor 1102 via a corresponding hinged connection. When the airless tire 1106 of the wheel 1100 is not in use (e.g., when the wheel 1100 and/or a vehicle to which the wheel 1100 is attached is/are actively being transported), the foldable spokes 1104 can be rotated inwardly (e.g., via the hinged connections) within the open central region 1112 of the electric motor 1102, as shown in FIG. 13. The outer tread 1114 of the airless tire 1106 can also be located within the open central region 1112 when the wheel 1100 is not in use.

The wheel 1100 of FIGS. 11-13 can be used with and/or incorporated into many different types of applications. For example, the wheel 1100 of FIGS. 11-13 can be used with and/or incorporated into various wheel-based vehicles (e.g., cars, trucks, motorcycles, scooters, etc.). In some examples, the wheel 1100 of FIGS. 11-13 is particularly suitable for use with and/or incorporation into a moon buggy that is configured for space exploration. Some modern moon buggies include shape memory metal tires that compress (e.g., retract) when the moon buggy is in transport and decompress (e.g. expand) when the moon buggy is in drive mode. The airless tire 1106 of the wheel 1100 of FIGS. 11-13 offers numerous advantages over shape memory metal tires with regard to weight savings, cost reduction, and performance optimization.

FIGS. 1-13 described above provide various examples of electric motors having one or more structure(s) coupled and/or attached to the rotor of the electric motor. In other some examples, a wire or cable can be coupled and/or attached to a rotor of an electric motor. For example, the exterior surface of a rotor of an electric motor can be configured with one or more groove(s) and/or track(s) that facilitate guided winding of a wire or cable around the rotor of the electric motor as the rotor of the electric motor rotates. Use cases for such an electric motor include, for example, a winch system. In some examples, such an electric motor can further incorporate a planetary gear assembly similar to the above-described planetary gear assembly 404 of the electric motor 400 of FIGS. 4-7.

The following paragraphs provide various examples in relation to the disclosed rotor attachments for electric motors.

Example 1 is an electric motor. In Example 1, the electric motor comprises a stator. In Example 1, the electric motor further comprises a rotor circumscribing the stator. The rotor is configured to rotate relative to the stator. In Example 1, the electric motor further comprises a sprocket circumscribing the rotor. The sprocket is coupled to the rotor such that rotation of the rotor causes a corresponding rotation of the sprocket. The sprocket includes a plurality of teeth projecting in a radially-outward direction. Respective ones of the plurality of teeth are configured to operatively engage a structure such that the corresponding rotation of the sprocket causes movement of the structure.

Example 2 includes the electric motor of Example 1. In Example 2, the sprocket is removably coupled to the rotor via a plurality of fasteners.

Example 3 includes the electric motor of Example 2. In Example 3, the rotor includes a face having a plurality of openings formed therein, and the sprocket includes a lip having a plurality of openings formed therein and extending therethrough. Respective ones of the plurality of openings of the lip of the sprocket are aligned with corresponding respective ones of the plurality of openings of the face of the rotor. Respective ones of the plurality of fasteners extend through the respective ones of the openings formed in the lip of the sprocket and into the corresponding respective ones of the openings formed in the face of the rotor to removably couple the sprocket to the rotor.

Example 4 includes the electric motor of Example 1. In Example 4, the sprocket is integrally formed with the rotor.

Example 5 includes the electric motor of Example 1. In Example 5, the sprocket has an axial width that is substantially equal to an axial width of the rotor.

Example 6 includes the electric motor of Example 1. In Example 6, the electric motor further comprises an open central region located radially inward relative to the sprocket, relative to the rotor, and relative to the stator. The open central region is unobstructed by the sprocket.

Example 7 includes the electric motor of Example 1. In Example 7, the structure is a surface, a gear, a belt, a chain, a cable, or a cord.

Example 8 is an electric motor. In Example 8, the electric motor comprises a stator. In Example 8, the electric motor further comprises a rotor circumscribing the stator. The rotor is configured to rotate relative to the stator. In Example 8, the electric motor further comprises a planetary gear assembly operatively coupled to the rotor. The planetary gear assembly includes a sprocket circumscribing the rotor. Rotation of the rotor at a first rotational speed causes a corresponding rotation of the sprocket at a second rotational speed that differs from the first rotational speed. The sprocket includes a plurality of teeth projecting in a radially-outward direction. Respective ones of the plurality of teeth are configured to operatively engage a structure such that the corresponding rotation of the sprocket causes movement of the structure.

Example 9 includes the electric motor of Example 8. In Example 9, the second rotational speed of the sprocket is less than the first rotational speed of the rotor.

Example 10 includes the electric motor of Example 8. In Example 10, the planetary gear assembly further includes an attachment plate coupled to the stator. The attachment plate is fixed relative to the stator. In Example 10, the planetary gear assembly further includes a first ring gear coupled to or integrally formed with the rotor. Rotation of the rotor causes rotation of the first ring gear. In Example 10, the planetary gear assembly further includes a plurality of first planet gears configured to operatively engage the first ring gear. Each one of the plurality of first planet gears is rotatably coupled to the attachment plate. Each one of the plurality of first planet gears is rotatable about a corresponding central axis relative to the attachment plate. Rotation of the first ring gear causes rotation of respective ones of the plurality of first planet gears. In Example 10, the planetary gear assembly further includes a central gear configured to operatively engage the respective ones of the plurality of first planet gears. Rotation of the respective ones of the plurality of first planet gears causes rotation of the central gear. In Example 10, the planetary gear assembly further includes a plurality of second planet gears configured to operatively engage the central gear. Each one of the plurality of second planet gears being rotatably coupled to the attachment plate. Each one of the plurality of second planet gears being rotatable about a corresponding central axis relative to the attachment plate. Rotation of the central gear causes rotation of respective ones of the plurality of second planet gears. In Example 10, the planetary gear assembly further includes a second ring gear configured to operatively engage the respective ones of the second planet gears. Rotation of the respective ones of the second planet gears causes rotation of the second ring gear. The sprocket is coupled to or integrally formed with the second ring gear. Rotation of the second ring gear causes the corresponding rotation of the sprocket.

Example 11 includes the electric motor of Example 10. In Example 11, the planetary gear assembly further includes a cover configured to retain the plurality of first planet gears, the plurality of second planet gears, the central gear, and the second ring gear relative to the rotor.

Example 12 includes the electric motor of Example 10. In Example 12, the sprocket has an axial width that is substantially equal to an axial width of the second ring gear.

Example 13 includes the electric motor of Example 10. In Example 13, the sprocket has an axial width that is substantially equal to an axial width of the rotor.

Example 14 includes the electric motor of Example 10. In Example 14, the first ring gear and the second ring gear respectively include a plurality of teeth projecting in a radially-inward direction.

Example 15 includes the electric motor of Example 8. In Example 8, the structure is a surface, a gear, a belt, a chain, a cable, or a cord.

Example 16 is a wheel. In Example 16, the wheel comprises an electric motor including a stator and a rotor. The rotor circumscribes the stator. The rotor is configured to rotate relative to the stator. In Example 16, the wheel further comprises an airless tire including an inner core, an outer tread spaced radially apart from the inner core, and a plurality of flexible spokes extending between an exterior surface of the inner core and an interior surface of the outer tread. The inner core of the airless tire is coupled to the rotor. Rotation of the rotor causes a corresponding rotation of the airless tire.

Example 17 includes the wheel of Example 16. In Example 17, the inner core, the flexible spokes, and the outer tread of the airless tire are respectively formed from plastic or rubber.

Example 18 includes the wheel of Example 16. In Example 18, the wheel further comprises an open central region located radially inward relative to the airless tire, relative to the rotor, and relative to the stator. The open central region is unobstructed by the airless tire.

Example 19 is a wheel. In Example 19, the wheel comprises an electric motor including a stator, a rotor, and an open central region. The rotor circumscribes the stator. The rotor is configured to rotate relative to the stator. The open central region is located radially inward relative to the rotor and relative to the stator. In Example 19, the wheel further comprises a plurality of foldable spokes rotatably coupled to the rotor. Each one of the plurality of foldable spokes is movable relative to the rotor between a stowed position in which a portion of the foldable spoke is located radially within the open central region and a deployed position in which the portion of the foldable spoke is located radially outside of the open central region. In Example 19, the wheel further comprises an airless tire selectively coupled to the rotor via respective ones of the plurality of foldable spokes. The airless tire includes an outer tread that circumscribes and is spaced radially apart from the rotor when the airless tire is coupled to the respective ones of the plurality of foldable spokes and the respective ones of the plurality of foldable spokes are in the deployed position. Rotation of the rotor causes a corresponding rotation of the airless tire when the airless tire is coupled to the respective ones of the plurality of foldable spokes and the respective ones of the plurality of foldable spokes are in the deployed position.

Example 20 includes the wheel of Example 19. In Example 20, the outer tread of the airless tire is formed from plastic or rubber.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An electric motor, comprising:
a stator;
a rotor circumscribing the stator, the rotor configured to rotate relative to the stator; and
a sprocket circumscribing the rotor, the sprocket coupled to the rotor such that rotation of the rotor causes a corresponding rotation of the sprocket, the sprocket including a plurality of teeth projecting in a radially-outward direction, respective ones of the plurality of teeth configured to operatively engage a structure such that the corresponding rotation of the sprocket causes movement of the structure.

2. The electric motor of claim 1, wherein the sprocket is removably coupled to the rotor via a plurality of fasteners.

3. The electric motor of claim 2, wherein the rotor includes a face having a plurality of openings formed therein, wherein the sprocket includes a lip having a plurality of openings formed therein and extending therethrough, wherein respective ones of the plurality of openings of the lip of the sprocket are aligned with corresponding respective ones of the plurality of openings of the face of the rotor, and wherein respective ones of the plurality of fasteners extend through the respective ones of the openings formed in the lip of the sprocket and into the corresponding respective ones of the openings formed in the face of the rotor to removably couple the sprocket to the rotor.

4. The electric motor of claim 1, wherein the sprocket is integrally formed with the rotor.

5. The electric motor of claim 1, wherein the sprocket has an axial width that is substantially equal to an axial width of the rotor.

6. The electric motor of claim 1, further comprising an open central region located radially inward relative to the sprocket, relative to the rotor, and relative to the stator, wherein the open central region is unobstructed by the sprocket.

7. The electric motor of claim 1, wherein the structure is a surface, a gear, a belt, a chain, a cable, or a cord.

8. An electric motor, comprising:
a stator;
a rotor circumscribing the stator, the rotor configured to rotate relative to the stator; and
a planetary gear assembly operatively coupled to the rotor, the planetary gear assembly including a sprocket circumscribing the rotor, wherein rotation of the rotor at a first rotational speed causes a corresponding rotation of the sprocket at a second rotational speed that differs from the first rotational speed, the sprocket including a plurality of teeth projecting in a radially-outward direction, respective ones of the plurality of teeth configured to operatively engage a structure such that the corresponding rotation of the sprocket causes movement of the structure.

9. The electric motor of claim 8, wherein the second rotational speed of the sprocket is less than the first rotational speed of the rotor.

10. The electric motor of claim 8, wherein the planetary gear assembly further includes:
an attachment plate coupled to the stator, the attachment plate fixed relative to the stator;
a first ring gear coupled to or integrally formed with the rotor, wherein rotation of the rotor causes rotation of the first ring gear;
a plurality of first planet gears configured to operatively engage the first ring gear, each one of the plurality of first planet gears being rotatably coupled to the attachment plate, each one of the plurality of first planet gears being rotatable about a corresponding central axis relative to the attachment plate, wherein rotation of the first ring gear causes rotation of respective ones of the plurality of first planet gears;
a central gear configured to operatively engage the respective ones of the plurality of first planet gears, wherein rotation of the respective ones of the plurality of first planet gears causes rotation of the central gear;
a plurality of second planet gears configured to operatively engage the central gear, each one of the plurality of second planet gears being rotatably coupled to the attachment plate, each one of the plurality of second planet gears being rotatable about a corresponding central axis relative to the attachment plate, wherein rotation of the central gear causes rotation of respective ones of the plurality of second planet gears; and
a second ring gear configured to operatively engage the respective ones of the second planet gears, wherein rotation of the respective ones of the second planet gears causes rotation of the second ring gear, wherein the sprocket is coupled to or integrally formed with the second ring gear, wherein rotation of the second ring gear causes the corresponding rotation of the sprocket.

11. The electric motor of claim 10, wherein the planetary gear assembly further includes a cover configured to retain the plurality of first planet gears, the plurality of second planet gears, the central gear, and the second ring gear relative to the rotor.

12. The electric motor of claim 10, wherein the sprocket has an axial width that is substantially equal to an axial width of the second ring gear.

13. The electric motor of claim 10, wherein the sprocket has an axial width that is substantially equal to an axial width of the rotor.

14. The electric motor of claim 10, wherein the first ring gear and the second ring gear respectively include a plurality of teeth projecting in a radially-inward direction.

15. The electric motor of claim 8, wherein the structure is a surface, a gear, a belt, a chain, a cable, or a cord.

16. A wheel, comprising:
an electric motor including a stator and a rotor, the rotor circumscribing the stator, the rotor configured to rotate relative to the stator; and
an airless tire including an inner core, an outer tread spaced radially apart from the inner core, and a plurality of flexible spokes extending between an exterior surface of the inner core and an interior surface of the outer tread, wherein the inner core of the airless tire is coupled to the rotor, wherein rotation of the rotor causes a corresponding rotation of the airless tire.

17. The wheel of claim 16, wherein the inner core, the flexible spokes, and the outer tread of the airless tire are respectively formed from plastic or rubber.

18. The wheel of claim 16, further comprising an open central region located radially inward relative to the airless tire, relative to the rotor, and relative to the stator, wherein the open central region is unobstructed by the airless tire.

19. A wheel, comprising:
an electric motor including a stator, a rotor, and an open central region, the rotor circumscribing the stator, the rotor configured to rotate relative to the stator, the open central region located radially inward relative to the rotor and relative to the stator;
a plurality of foldable spokes rotatably coupled to the rotor, each one of the plurality of foldable spokes being movable relative to the rotor between a stowed position in which a portion of the foldable spoke is located radially within the open central region and a deployed position in which the portion of the foldable spoke is located radially outside of the open central region; and
an airless tire selectively coupled to the rotor via respective ones of the plurality of foldable spokes, the airless tire including an outer tread that circumscribes and is spaced radially apart from the rotor when the airless tire is coupled to the respective ones of the plurality of foldable spokes and the respective ones of the plurality of foldable spokes are in the deployed position, wherein rotation of the rotor causes a corresponding rotation of the airless tire when the airless tire is coupled to the respective ones of the plurality of foldable spokes and the respective ones of the plurality of foldable spokes are in the deployed position.

20. The wheel of claim 19, wherein the outer tread of the airless tire is formed from plastic or rubber.
